(19) United States
(12) Patent Application Publication
(10) Pub. No.: US 2006/0183642 A1
(43) Pub. Date: Aug. 17, 2006

(54) Herbicidal composition

(75) Inventors: Toshiro Otsubo, Sanda-shi (JP); Atsushi Watanabe, Toyonaka-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 11/058,284

(22) Filed: Feb. 16, 2005

(51) Int. Cl. A01N 35/10; A01N 25/16

(52) U.S. Cl. 504/344; 504/364

(57) ABSTRACT

An herbicidal composition comprising i) 5 to 40% by weight of clethodim, ii) 0.1 to 10% by weight of sulfonate surfactant, iii) 0.1 to 30% by weight of at least one nonionic surfactant selected from the group consisting of polyoxyalkylene fatty alcohol ether and polyoxyalkylene alkylphenyl ether, and iv) 50 to 94.8% by weight of aromatic hydrocarbon gives good stability of the emulsion after it is diluted with water.

### FIELD OF THE INVENTION

The present invention relates to a herbicidal composition.

### BACKGROUND ARTS

Some compositions containing a herbicidal cyclohexanedione compound are known in U.S. Pat. No. 4,626,276, U.S. Pat. No. 4,741,768, U.S. Pat. No. 5,084,087 and U.S. Pat. No. 5,554,576. In U.S. Pat. No. 5,084,087, a ready-to-dilute herbicidal composition comprising a cyclohexanone herbicide, a polyoxyethylene nonionic surfactant having an HLB of from 10 to 14, anionic surfactant of dialkylsulfosuccinate or metal alkylaromatic sulfonate, polyoxyalkylene nonionic surfactant having an HLB of less than 10 and alkanol ester of fatty acid is described.

### SUMMARY OF THE INVENTION

The present invention provides a herbicidal composition comprising i) 5 to 40% by weight of of clethodim, ii) 0.1 to 10% by weight of sulfonate surfactant, iii) 0.1 to 30% by weight of at least one nonionic surfactant selected from the group consisting of polyoxyalkylene fatty alcohol ether and polyoxyalkylene alkylphenyl ether and iv) 50 to 94.8% by weight of aromatic hydrocarbon.

According to the present invention, the composition containing clethodim can provide a stable emulsion when it is diluted with hard water as well as normal water.

### DETAILED DESCRIPTION OF THE INVENTION

In the present invention, clethodim is an herbicidal ingredient, and the chemical name of clethodim is (±)-2-[(E)-1-[(E)-3-chloroallyloxyimino] propyl]-5-[2-(ethylthio)propyl]-3-hydroxyclclohex-2-enone of the formula: 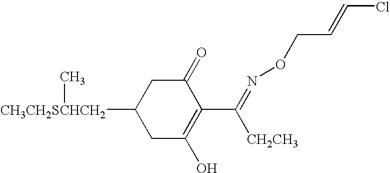
It can be obtained in the market, for example, it is provided by Valent U.S.A. Corporation, Tomen Agro, Inc. or Arvesta Corporation.

The content of clethodim in the herbicidal composition of the present invention is 5 to 40% by weight, preferably 10 to 30% by weight.

The sulfonate surfactant means an anionic surfactant having at least one sulfonic acid salt group in the molecule. Examples of the sulfonate surfactant include salts of alkylbenzene sulfonic acid (e.g., (C8-C15 alkyl)benzenesulfonate), salts of alkylnaphthalene sulfonic acid, salts of alkylsulfonic acid, salts of alkyl ether sulfonic acid, salts of fatty alcohol ether sulfonic acid and salts of polyoxyalkylene tristyrylphenyl ether sulfonic acid. Typical examples of the salt are calcium, sodium and potassium salts. Typical examples of the sulfonate are dodecylbenzenesulfonate, diisopropylnaphthalenesulfonate, diisobutylnaphthalenesulfonate, α-olefinsulfonate and dialkylsulfosuccinate. Among them, calcium dodecylbenzenesulfonate, sodium dodecylbenzenesulfonate and potassium dodecylbenzenesulfonate are preferably used.

The content of the sulfonate surfactant in the herbicidal composition of the present invention is 0.1 to 10% by weight, preferably 0.1 to 5% by weight.

The polyoxyalkylene fatty alcohol ether is a nonionic surfactant that is polyoxyalkylated fatty alcohol. It is also known as polyoxyalkylene alkyl ether and it is typically given by the formula: R—O—(AO)ₙH, wherein R is a higher alkyl which may contain one or more carbon-carbon double bonds, on the other word, R may be alkenyl, (AO)ₙ is polyoxyethylene, polyoxypropylene or polyoxyethylene polyoxypropylene block copolymer and n is 2 to 30. It can be produced by an addition of alkylene oxide to fatty alcohol. Typical examples of the polyoxyalkylene fatty alcohol ether include polyoxyethylene lauryl ether, polyoxyethylene octyl ether, polyoxyethylene myristyl ether, polyoxyethylene stearyl ether and polyoxyethylene oleyl ether. It is prepared by addition of alkylene oxide (e.g., ethylene oxide, propylene oxide) of fatty alcohol, namely C10-C22 aliphatic alcohol.

The HLB of the polyoxyalkylene fatty alcohol ether is preferably 9 to 17. HLB means Hydrophilic-Lipophilic Balance which is well known in the field of surfactant.

The polyoxyalkylene alkylphenyl ether is also known as polyoxyalkylene alkylphenol and it means a nonionic surfactant that is polyoxyalkylated alkylphenol. It can be produced by an addition of alkylene oxide to alkylphenol. It is typically given by the formula: R—C₆H₄—O—(AO)ₙH, wherein R is an alkyl, (AO)ₙ is polyoxyethylene, polyoxypropylene or polyoxyethylene polyoxypropylene block copolymer and n is 2 to 50. Typical examples of the polyoxyalkylene alkylphenyl ether include polyoxyethylene nonylphenyl ether and polyoxyethylene octylphenyl ether.

The HLB of the polyoxyalkylene alkylphenyl ether is generally 10 to 16, preferably 11 to 14.

The content of the polyoxyalkylene fatty alcohol ether and/or polyoxyalkylene alkylphenyl ether in the herbicidal composition of the present invention is 0.1 to 30% by weight, preferably 0.1 to 20% by weight.

The aromatic hydrocarbon is generally a solvent that can dissolve clethodim. Namely, the aromatic hydrocarbon is usually used in the amount that can dissolve the clethodim contained in the herbicidal composition.

Examples of the aromatic hydrocarbon include xylene, phenylxylylethane, Hisol SAS-296 (a mixture of 1-phenyl-1-xylylethane and 1-phenyl-1-ethylphenylethane, commercial name of Nippon Petroleum Company), Cactus Solvent HP-DMN (containing 80% of dimethylnaphthalene, commercial name of Nikko Petrochemical Company), Cactus Solvent P-100 (alkylbenzene having 9 to 10 of carbon number, commercial name of Nikko Petrochemical Company), Aromatic 150 (aromatic hydrocarbon, commercial name of ExxonMobil Chemical) and Aromatic 200 (aromatic hydrocarbon, commercial name of ExxonMobil Chemical).

The content of the aromatic hydrocarbon in the herbicidal composition of the present invention is 50 to 94.8% by weight, preferably 65 to 89.8% by weight.

Further, the herbicidal composition optionally comprises the other solvent, auxiliaries such as esters of fatty acid, antioxidant (e.g., propyl gallate), fungicide, perfume, dyestuff, and so on.

Examples of the esters of fatty acid include methyl oleate, methyl palmitate, methyl laurate, isopropyl myristate, isopropyl palmitate, octyl laurate, octyl palmitate and butyl stearate.

The herbicidal composition of the present invention can be prepared by mixing i) clethodim, ii) sulfonate surfactant, iii) polyoxyalkylene fatty alcohol ether/polyoxyalkylene alkylphenyl ether and iv) aromatic hydrocarbon, and optionally the other solvent, auxiliaries and so on.

The herbicidal composition of the present invention is utilized as an emulsifiable concentrate in general, namely it is diluted with water to give an emulsion and applied to weeds, especially graminaceous weeds such as Agropyron tsukushiense, barnyardgrass (Echinochloa crus-galli), green foxtail (Setaria viridis), giant foxtail (Setaria faberi), large crabgrass (Digitaria sanguinalis), annual bluegrass (Poa annua), blackgrass (Alopecurus myosuroides), oats (Avena sativa), wild oats (Avena fatua), johnsongrass (Sorghum halepense), quackgrass (Agropyron repens), downy brome (Bromus tectorum) and bermudagrass (Cynodon dactylon) in broad-leaf crop (e.g. soybean, cotton, sugarbeet, peanut) fields. The application dosage is generally 10 g to 1000 g per hectare in the amount of clethodim, although it may vary with the kinds of objective weeds, weather conditions and so on. The dilution of the herbicidal composition can also be used for aerial application by helicopter, plane or radio-controlled helicopter. The herbicidal composition of the present invention may be diluted with water containing a spreading agent. Examples of the spreading agent include Agridex (commercial name of Helena Chemical Corporation), Dynamic (commercial name of Helena Chemical Corporation), Induce (commercial name of Helena Chemical Corporation) and Silwet L-77 (manufactured by Nihon Unicar).

### EXAMPLES

Hereinafter, the present invention is explained in more detail referring to examples, but the present invention should not be limited in the following examples.

### Example 1

The following ingredients were thoroughly mixed to give a herbicidal composition of the present invention.

| | | |
|---|---|---|
| Clethodim (purity: 93%) | 13.50 | wt % |
| Calcium dodecylbenzenesulfonate (60% | 1.67 | wt % |
| calcium dodecylbenzenesulfonate | | |
| in 2-ethylhexanol, Agnique ABS | | |
| 60C supplied by Cognis) | | |
| Polyoxyethylene lauryl ether (HLB | 9.00 | wt % |
| 9.2, average molecular weight: about | | |
| 200, product name: BRIJ 30 supplied by Uniqema) | | |
| Aromatic 150 (aromatic hydrocarbon, | 75.83 | wt % |
| commercial name of ExxonMobil | | |
| Chemical) | | |

### Example 2

The following ingredients were thoroughly mixed to give a herbicidal composition of the present invention.

| | | |
|---|---|---|
| Clethodim (purity: 93%) | 13.50 | wt % |
| Calcium dodecylbenzenesulfonate | 1.67 | wt % |
| (60% calcium dodecylbenzenesulfonate | | |
| in 2-ethylhexanol, Agnique ABS | | |
| 60C supplied by Cognis) | | |
| Polyoxyethylene alkyl ether (HLB | 9.00 | wt % |
| 9.6, Pegnol O-6A supplied by Toho | | |
| Chemical Industry) | | |
| Aromatic 150 (aromatic hydrocarbon, | 75.83 | wt % |
| commercial name of ExxonMobil | | |
| Chemical) | | |

### Example 3

The following ingredients were thoroughly mixed to give a herbicidal composition of the present invention.

| | | |
|---|---|---|
| Clethodim (purity: 93%) | 13.50 | wt % |
| Calcium dodecylbenzenesulfonate | 3.34 | wt % |
| (60% calcium dodecylbenzenesulfonate | | |
| in 2-ethylhexanol, Agnique ABS | | |
| 60C supplied by Cognis) | | |
| Polyoxyethylene lauryl ether (HLB | 9.00 | wt % |
| 16.9, average molecular weight: about | | |
| 1030, product name: BRIJ 35 Liq/Gel | | |
| supplied by Uniqema) | | |
| Aromatic 150 (aromatic hydrocarbon, | 75.83 | wt % |
| commercial name of ExxonMobil | | |
| Chemical) | | |

### Example 4

The following ingredients were thoroughly mixed to give a herbicidal composition of the present invention.

| | | |
|---|---|---|
| Clethodim (purity: 93%) | 13.50 | wt % |
| Calcium dodecylbenzenesulfonate | 3.34 | wt % |
| (60% calcium dodecylbenzenesulfonate | | |
| in 2-ethylhexanol, Agnique ABS | | |
| 60C supplied by Cognis) | | |
| Polyoxyethylene alkyl ether (HLB | 2.00 | wt % |
| 12.9, Pegnol L-4 supplied by Toho | | |
| Chemical Industry) | | |
| Aromatic 150 (aromatic hydrocarbon, | 81.16 | wt % |
| commercial name of ExxonMobil | | |
| Chemical) | | |

### Example 5

The following ingredients were thoroughly mixed to give a herbicidal composition of the present invention.

| | | |
|---|---|---|
| Clethodim (purity: 93%) | 13.50 | wt % |
| Calcium dodecylbenzenesulfonate | 3.34 | wt % |
| (60% calcium dodecylbenzenesulfonate | | |
| in 2-ethylhexanol, Agnique ABS | | |
| 60C supplied by Cognis) | | |
| Polyoxyethylene alkyl ether (HLB | 2.00 | wt % |
| 14.5, Sorpol ST-12 supplied by Toho | | |
| Chemical Industry) | | |
| Aromatic 150 (aromatic hydrocarbon, | 81.16 | wt % |
| commercial name of ExxonMobil | | |
| Chemical) | | |

### Example 6

The following ingredients were thoroughly mixed to give a herbicidal composition of the present invention.

| | | |
|---|---|---|
| Clethodim (purity: 93%) | 13.50 | wt % |
| Calcium dodecylbenzenesulfonate (60% | 1.67 | wt % |
| calcium dodecylbenzenesulfonate | | |
| in 2-ethylhexanol, Agnique ABS 60C | | |
| supplied by Cognis) | | |
| Polyoxyethylene nonylphenyl ether | 9.00 | wt % |
| (HLB 12, Makon 8 supplied by Stepan) | | |
| Aromatic 150 (aromatic hydrocarbon, | 75.83 | wt % |
| commercial name of ExxonMobil | | |
| Chemical) | | |

### Example 7

The following ingredients were thoroughly mixed to give a herbicidal composition of the present invention.

| | | |
|---|---|---|
| Clethodim (purity: 93%) | 13.50 | wt % |
| Calcium dodecylbenzenesulfonate (60% | 1.67 | wt % |
| calcium dodecylbenzenesulfonate | | |
| in 2-ethylhexanol, Agnique ABS 60C | | |
| supplied by Cognis) | | |
| Polyoxyethylene nonylphenyl ether | 9.00 | wt % |
| (HLB 13, Makon 10 supplied by | | |
| Stepan) | | |
| Aromatic 150 (aromatic hydrocarbon, | 75.83 | wt % |
| commercial name of ExxonMobil | | |
| Chemical) | | |

### Example 8

The following ingredients were thoroughly mixed to give a herbicidal composition of the present invention.

| | | |
|---|---|---|
| Clethodim (purity: 93%) | 13.50 | wt % |
| Calcium dodecylbenzenesulfonate (60% | 3.34 | wt % |
| calcium dodecylbenzenesulfonate | | |
| in 2-ethylhexanol, Agnique ABS 60C | | |
| supplied by Cognis) | | |
| Polyoxyethylene nonylphenyl ether | 2.00 | wt % |
| (HLB 14, Makon 12 supplied by | | |
| Stepan) | | |
| Aromatic 150 (aromatic hydrocarbon, | 81.16 | wt % |
| commercial name of ExxonMobil | | |
| Chemical) | | |

### Reference Example 1

The following ingredients were thoroughly mixed to give a herbicidal composition for reference.

| | | |
|---|---|---|
| Clethodim (purity: 93%) | 13.50 | wt % |
| Calcium dodecylbenzenesulfonate (60% | 1.67 | wt % |
| calcium dodecylbenzenesulfonate | | |
| in 2-ethylhexanol, Agnique ABS 60C | | |
| supplied by Cognis) | | |
| Polyoxyethylene alkyl ether (HLB 9.6, | 9.00 | wt % |
| Pegnol O6A supplied by Toho | | |
| Chemical Industry) | | |
| Methyl oleate (Agnique ME 181-U | 40.00 | wt % |
| supplied by Cognis) | | |
| Aromatic 150 (aromatic hydrocarbon, | 35.83 | wt % |
| commercial name of ExxonMobil | | |
| Chemical) | | |

### Reference Example 2

The following ingredients were thoroughly mixed to give a herbicidal condition for reference.

| | | |
|---|---|---|
| Clethodim (purity: 93%) | 13.50 | wt % |
| Calcium dodecylbenzenesulfonate (60% | 1.67 | wt % |
| calcium dodecylbenzenesulfonate | | |
| in 2-ethylhexanol, Agnique ABS | | |
| 60C supplied by Cognis) | | |
| Polyoxyethylene alkyl ether (HLB 14.1, | 9.00 | wt % |
| Pegnol TE-10A supplied by Toho | | |
| Chemical Industry) | | |
| Methyl oleate (Agnique ME 181-U | 40.00 | wt % |
| supplied by Cognis) | | |
| Aromatic 150 (aromatic hydrocarbon, | 35.83 | wt % |
| commercial name of ExxonMobil | | |
| Chemical) | | |

### Test Example 1

342 ppm hard water (obtained by dissolving 3.04 g of anhydrous calcium chloride and 0.139 g of magnesium chloride hexahydrate in distilled water and making up to 1 litter) was charged in a 95 ml-cylinder with lid, and keep at room temperature. Then, 5 ml of each of the compositions obtained in Examples 1 to 8 and Reference Examples 1 to 2 was added. The cylinders were inverted 10 times in 20 seconds. After keeping the cylinders for two hours at room temperature, the separation of the top layer was observed as emulsion stability.

| Example No. | Emulsion stability |
|---|---|
| 1 | excellent |
| 2 | excellent |
| 3 | good |
| 4 | excellent |
| 5 | excellent |
| 6 | excellent |
| 7 | good |
| 8 | excellent |

The compositions obtained in Examples 1 to 8 gave good results as shown above; on the other hand, some separation of the top layer was observed in the compositions obtained in Reference Examples 1 to 2, which contain a large amount of an alkanol ester of fatty acid as given in U.S. Pat. No. 5,084,087 and thus contain a smaller amount of aromatic hydrocarbon than the herbicidal composition of the present invention.

We claim:

1. A herbicidal composition which comprises 5 to 40% by weight of clethodim, 0.1 to 10% by weight of sulfonate surfactant, 0.1 to 30% by weight of at least one nonionic surfactant selected from the group consisting of polyoxyalkylene fatty alcohol ether and polyoxyalkylene alkylphenyl ether, and 50 to 94.8% by weight of aromatic hydrocarbon.

2. The herbicidal composition according to claim 1, which comprises 10 to 30% by weight of clethodim, 0.1 to 5% by weight of a sulfonate surfactant, 0.1 to 20% by weight of at least one nonionic surfactant selected from the group consisting of polyoxyalkylene fatty alcohol ether and polyoxyalkylene alkylphenyl ether, and 65% to 89.8% by weight of an aromatic hydrocarbon.

3. The herbicidal composition according to claim 1, which comprises 5 to 40% by weight of clethodim, 0.1 to 10% by weight of sulfonate surfactant, 0.1 to 30% by weight of a polyoxyalkylene fatty alcohol ether and 50 to 94.8% by weight of aromatic hydrocarbon.

4. The herbicidal composition according to claim 3, wherein the polyoxyalkylene fatty alcohol ether has an HLB of from 9 to 17.

5. The herbicidal composition according to claim 1, which comprises 5 to 40% by weight of clethodim, 0.1 to 10% by weight of sulfonate surfactant, 0.1 to 30% by weight of polyoxyalkylene alkylphenyl ether and 50 to 94.8% by weight of aromatic hydrocarbon.

6. The herbicidal composition according to claim 5, wherein the polyoxyalkylene alkylphenyl ether has an HLB of from 10 to 16.

7. The herbicidal composition according to any of claims 1 to 6, wherein the sulfonate surfactant is a salt of dodecylbenzenesulfonic acid.
